(19) United States
(12) Patent Application Publication
(10) Pub. No.: US 2026/0260510 A1
(43) Pub. Date: Sep. 3, 2026

(54) IMAGE PROCESSING DEVICE, IMAGE PROCESSING METHOD, AND NON-TRANSITORY COMPUTER-READABLE MEDIUM

(71) Applicant: NEC Corporation, Tokyo (JP)

(72) Inventors: Masahito SAKAI, Tokyo (JP); Kosuke TONO, Tokyo (JP); Daisuke MORI, Tokyo (JP); Hisahiro OBA, Tokyo (JP)

(73) Assignee: NEC Corporation, Tokyo (JP)

(21) Appl. No.: 19/163,073

(22) PCT Filed: Mar. 23, 2023
(86) PCT No.: PCT/JP2023/011580

§ 371 Date: Sep. 8, 2025

(51) Int. Cl. G06V 40/16; G06F 21/62; G06T 5/70; G06T 11/60; G06V 20/58

(52) U.S. Cl. CPC G06V 40/161; G06F 21/6254; G06T 5/70; G06T 11/60; G06V 20/58; G06T 2207/30201

(57) ABSTRACT

An image processing device is provided with: an image acquisition unit that acquires an image captured by an imaging device installed in a vehicle; a person area detection unit that detects, from the image, a person area estimated to represent a person; a face area detection unit that detects, from the image, a face area estimated to represent a face of the person; a first masking unit that masks at least a portion of the person area and the face area if the person area and the face area are detected from the image; a body part estimation unit that estimates a body part of the person from the face area if the face area is detected and the person area is not detected from the image; and a second masking unit that masks at least a portion of the detected face area and the estimated body part.

### TECHNICAL FIELD

The present disclosure relates to an image processing device, an image processing method, and a non-transitory computer-readable medium.

### BACKGROUND ART

Videos acquired by an imaging device such as a drive recorder provided in a vehicle are collected and used for various purposes. In a case where a person or the like is shown in a video, from the perspective of personal information protection, masking processing may be performed on a region where the person is shown.

PTL 1 describes a technology of performing concealment processing such as mosaicing or blurring on a region of a non-monitored person subject to privacy protection based on an evaluation value for each person.

### CITATION LIST

### Patent Literature

PTL 1: JP 2011-130203 A

### SUMMARY OF INVENTION

### Technical Problem

However, there is a case where a person cannot be appropriately detected. For example, a face of the person can be detected, but a part of a body of the person may not be detected. The personal information regarding a part of the body may be identified by clothing, a body shape, or the like. Therefore, there is a case where the masking processing on the detected person cannot be reliably performed for personal information protection.

The present disclosure has been made to solve such a problem, and an object of the present disclosure is to provide an image processing device, an image processing method, and a non-transitory computer-readable medium capable of accurately detecting and estimating a region of a person from an image and performing masking processing.

### Solution to Problem

According to an aspect of the present disclosure, there is provided an image processing device including
an image acquisition unit that acquires an image,
a person region detection unit that detects a person region estimated to be a person from the image,
a face region detection unit that detects a face region estimated to be a face of the person from the image,
a first masking unit that masks at least a part of the person region and the face region in a case where the person region and the face region are detected from the image,
a body part estimation unit that estimates a body part of the person from the face region in a case where the face region is detected and the person region is not detected from the image, and
a second masking unit that masks at least a part of the detected face region and the estimated body part.

According to another aspect of the present disclosure, there is provided an image processing method including
acquiring an image,
detecting a person region estimated to be a person from the image,
detecting a face region estimated to be a face of the person from the image,
masking at least a part of the person region and the face region in a case where the person region and the face region are detected from the image,
estimating a body part of the person from the face region in a case where the face region is detected and the person region is not detected from the image, and
masking at least a part of the detected face region and the estimated body part.

According to still another aspect of the present disclosure, there is provided a non-transitory computer-readable medium storing a program that causes a computer to
acquire an image,
detect a person region estimated to be a person from the image,
detect a face region estimated to be a face of the person from the image,
mask at least a part of the person region and the face region in a case where the person region and the face region are detected from the image,
estimate a body part of the person from the face region in a case where the face region is detected and the person region is not detected from the image, and
mask at least a part of the detected face region and the estimated body part.

According to still another aspect of the present disclosure, there is provided an image processing device including
an image acquisition unit that acquires an image,
a person region detection unit that detects a person region estimated to be a person from the image,
a face region detection unit that detects a face region estimated to be a face of the person from the image,
a first masking unit that masks at least a part of the person region and the face region in a case where the person region and the face region are detected from the image,
a face part estimation unit that estimates a face part from the person region in a case where the person region is detected and the face region is not detected from the image, and
a second masking unit that masks at least a part of the detected person region and the estimated face part.

According to still another aspect of the present disclosure, there is provided an image processing method including
acquiring an image,
detecting a person region estimated to be a person from the image,
detecting a face region estimated to be a face of the person from the image,
masking at least a part of the person region and the face region in a case where the person region and the face region are detected from the image,
estimating a face part from the person region in a case where the person region is detected and the face region is not detected from the image, and
masking at least a part of the detected person region and the estimated face part.

According to still another aspect of the present disclosure, there is provided a non-transitory computer-readable medium storing a program that causes a computer to
acquire an image,
detect a person region estimated to be a person from the image,
detect a face region estimated to be a face of the person from the image,
mask at least a part of the person region and the face region in a case where the person region and the face region are detected from the image,
estimate a face part from the person region in a case where the person region is detected and the face region is not detected from the image, and
mask at least a part of the detected person region and the estimated face part.

### Advantageous Effects of Invention

According to the present disclosure, it is possible to provide an image processing device and the like capable of accurately detecting and estimating a region of a person from an image and performing masking processing.

### BRIEF DESCRIPTION OF DRAWINGS

FIG. 1 is a block diagram illustrating a configuration of an image processing device according to a first example embodiment.

FIG. 2 is a diagram illustrating an example of an acquired video frame according to the first example embodiment.

FIG. 3 is a diagram illustrating another example of an acquired video frame according to the first example embodiment.

FIG. 4 is a flowchart illustrating an image processing method according to the first example embodiment.

FIG. 5 is a block diagram illustrating a configuration of an image processing system according to a second example embodiment.

FIG. 6 is a block diagram illustrating a configuration of an image processing device according to the second example embodiment.

FIG. 7 is a diagram illustrating another example of an acquired video frame according to the second example embodiment.

FIG. 8 is a flowchart illustrating an image processing method according to the second example embodiment.

FIG. 9 is a block diagram illustrating a configuration of an image processing device according to a third example embodiment.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description.

### First Example Embodiment

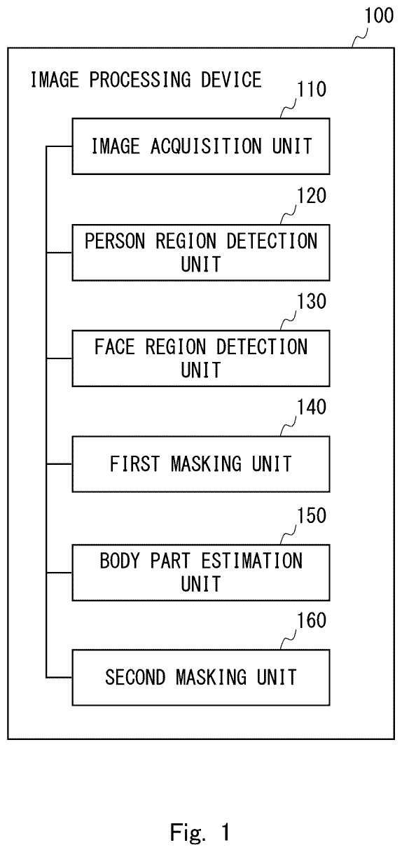

FIG. 1 is a block diagram illustrating a configuration of an image processing device 100 according to a first example embodiment. In a case where an image acquired from an imaging device that images the surroundings of a vehicle or a road includes a person, the image processing device 100 performs masking processing for concealing the person, their clothing, and the like in such a way as not to be able to be identified. The image processing device 100 includes an image acquisition unit 110, a person region detection unit 120, a face region detection unit 130, a first masking unit 140, a body part estimation unit 150, and a second masking unit 160. The image processing device 100 can be implemented by a computer including a processor and a memory. The image processing device 100 is connected to a wired or wireless network (not illustrated). An imaging device (not illustrated) or the like that images the surroundings of a vehicle is connected to the network. A video captured by the imaging device is a moving image and includes a plurality of consecutive frames arranged in chronological order of an imaging time. Here, a frame is still image data captured by the imaging device.

The image acquisition unit 110 acquires image frames of a video captured by the imaging device installed in the vicinity of a vehicle, a road, or the like. The video includes a plurality of frames. The video captured by the imaging device is transmitted to the image processing device 100 via the network.

The person region detection unit 120 detects a person region estimated to be a person from the video acquired by the image acquisition unit 110. Specifically, the person region detection unit 120 detects the person region for each frame included in the video using a known person region detection engine.

The face region detection unit 130 detects a face region estimated to be a face of a person from the image of the video acquired by the image acquisition unit 110. Specifically, the face region detection unit 130 detects the face region of the person for each frame included in the video using a known person's face region detection engine. The face region detection unit 130 also detects the face region of the person for the image frame in which the person region detection unit 120 detects the person region. The recognition accuracy of the person detection engine and the person face detection engine described above may be different even for the same person. In some examples, for example, the recognition accuracy of the person face detection engine may be higher than the person recognition accuracy of the person detection engine.

In a case where the person region and the face region are detected from the acquired image, the first masking unit 140 masks at least a part (for example, a part corresponding to a face, clothing, or the like) or all of the person region and the face region. That is, in a case where it is highly likely that the object detected by the person detection engine is a person, the first masking unit 140 performs various concealment processing in such a way that the person cannot be identified. Examples of masking include filling, mosaicing, and blurring on at least a part of the person region and the face region, but are not limited to thereto. Various masking methods that can be understood by those of ordinary skill in the art can be employed.

In a case where the face region is detected and the person region is not detected from the image, the body part estimation unit 150 estimates the body part of the person from the face region. Generally, it can be estimated that there is a body part below the position of the detected face region. The body part of the person may be estimated from the face region using various methods that can be understood by those of ordinary skill in the art.

The second masking unit 160 masks at least a part (part corresponding to a face, clothing, or the like) or all of the detected face region and the estimated body part.

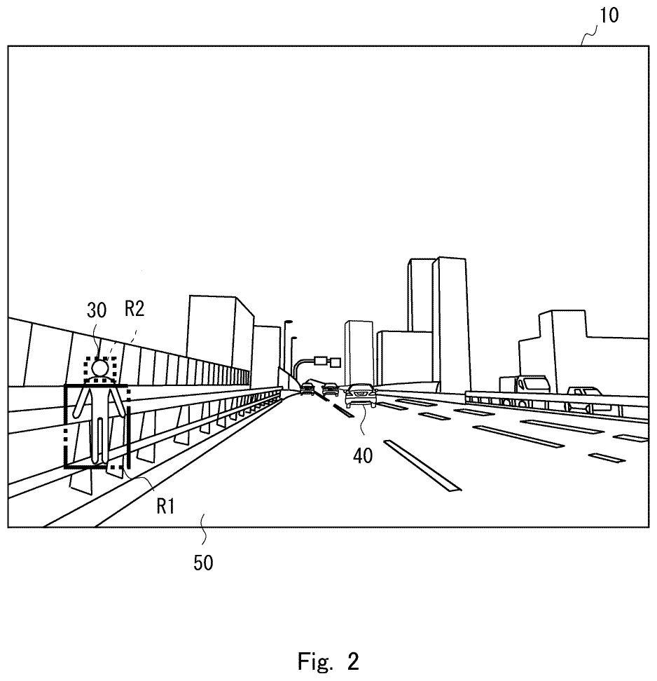

FIG. 2 illustrates an example of a frame 10 included in the acquired video. In the frame 10 illustrated in FIG. 2, a person 30 walking on a sidewalk and a vehicle 40 traveling forward on a roadway 50 are shown. In the example in FIG. 2, the person region detection unit 120 detects a person region RI that is a region including an image of the person 30. The face region detection unit 130 performs face detection processing on the same frame 10 in which the person region is detected. A face region R2 is detected. In this case, as described above, the first masking unit 140 masks at least a part (for example, a part corresponding to a face, clothing, or the like) or all of the person region and the face region.

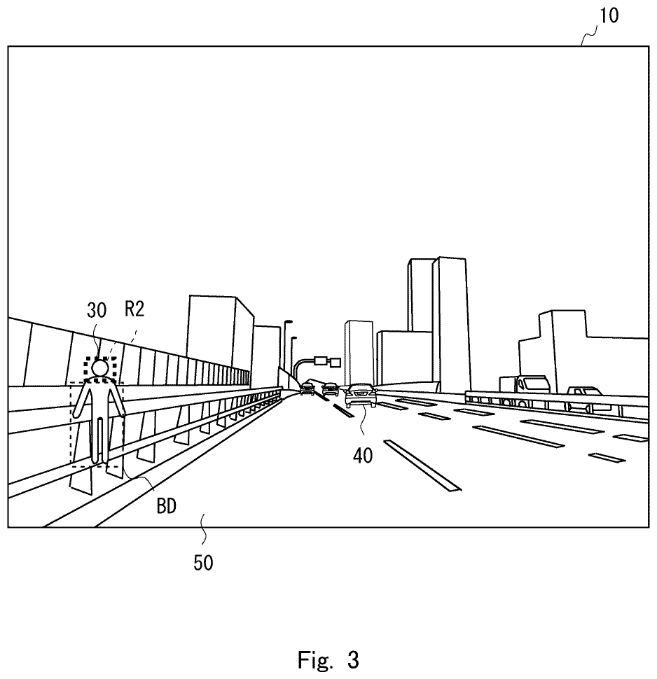

FIG. 3 illustrates another example of the frame 10 included in the acquired video.

In the example of FIG. 3, the face region R2 is detected by the face region detection unit 130, but the person region RI is not detected by the person region detection unit 120. In this case, it can be estimated that there is a body part BD of the person 30 between the face region R2 and the sidewalk below the face region R2. In some example embodiments, the body part may be estimated statistically based on attributes of the detected face (for example, age, gender, and race). The second masking unit 160 masks at least a part (part corresponding to a face, clothing, or the like) or all of the detected face region and the estimated body part. Thus, even in a case where the accuracy of person detection is low, it is possible to reliably protect personal information.

The estimation method described here is merely an example, and various estimation methods can be used based on the relationship between the face region and the body part, which can be understood by those of ordinary skill in the art.

The image processing device 100 includes a processor, a memory, and a storage device as components (not illustrated). The storage device stores a computer program in which processing of the image processing method according to the present example embodiment is implemented. The processor loads the computer program from the storage device into the memory and executes the computer program. Thus, the processor achieves functions as the image acquisition unit 110, the person region detection unit 120, the face region detection unit 130, the first masking unit 140, the body part estimation unit 150, and the second masking unit 160.

The image acquisition unit 110, the person region detection unit 120, the face region detection unit 130, the first masking unit 140, the body part estimation unit 150, and the second masking unit 160 may be implemented by dedicated hardware. Some or all of the components of each device may be implemented by general-purpose or dedicated circuitry, a processor, or a combination thereof. These components may be configured with a single chip or may be configured with a plurality of chips connected via a bus. Some or all of the components of each device may be implemented by a combination of the above-described circuitry or the like and a program. A central processing unit (CPU), a graphics processing unit (GPU), a field-programmable gate array (FPGA), or the like can be used as the processor.

In a case where some or all of the components of the image processing device 100 are implemented by a plurality of information processing devices, circuitry, or the like, the plurality of information processing devices, circuitry, or the like may be centralized or distributed. For example, each of the information processing devices, circuitry, or the like may be implemented in the form of a client server system, a cloud computing system, or the like in which they are connected to each other through a communication network. A function of the image processing device 100 may be provided in a software as a service (Saas) format.

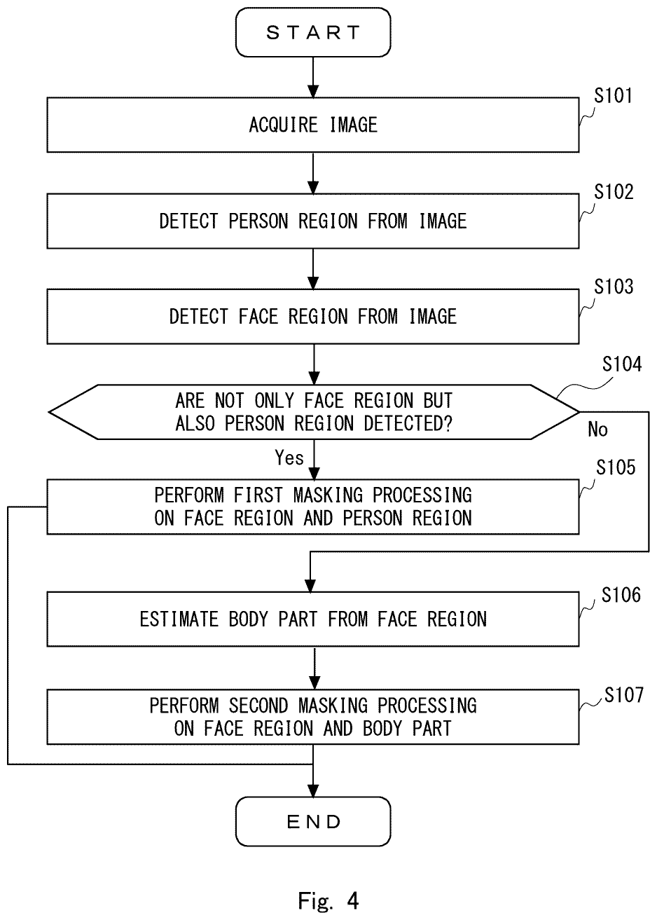

FIG. 4 is a flowchart illustrating the image processing method according to the first example embodiment.

The image acquisition unit 110 acquires image frames of a video captured by the imaging device provided in the vehicle (step S101). The acquired image frames are stored in the storage device together with an acquired time, an acquired positional information (for example, latitude, longitude, and the like), and other information (for example, the weather at the position).

The person region detection unit 120 detects a person region estimated to be a person from the video acquired by the image acquisition unit 110 using the known person region detection engine (step S102). The face region detection unit 130 detects a face region estimated to be a face of the person from the video acquired by the image acquisition unit 110 using the known face region detection engine (step S103).

As a result of the face region detection and the person region detection described above, in a case where both the face region and the person region are detected (Yes in step S104), the first masking unit 140 masks at least a part or all of the face region and the person region (step S105). Thereafter, the image processing ends. Thus, in a case where the probability that the detected object is a person is high, the person concealment processing can be performed using the person region detection engine and the face region detection engine.

On the other hand, as illustrated in FIG. 3, in a case where only the face region is detected and the person region is not detected (No in step S104), the body part is estimated from the face region (step S106). The second masking unit 160 masks at least a part or all of the detected face region and the estimated body part (step S107). Thus, even in a case where the detection accuracy of the person region detection engine is not good (for example, due to external environmental factors such as weather), it is possible to estimate the body part from the face region and perform masking processing. The body part can also be masked in such a way that the individual is not identified from the characteristic clothing, the characteristic body shape, and the like.

### Second Example Embodiment

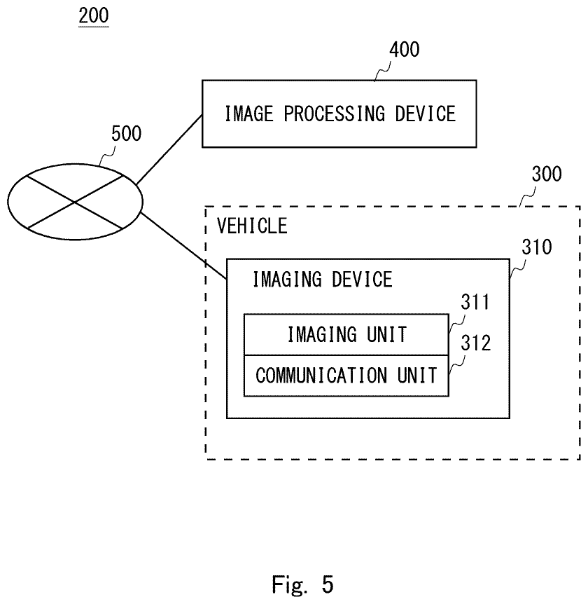

FIG. 5 is a block diagram illustrating a configuration of an image processing system 200 according to a second example embodiment. The image processing system 200 may include at least an imaging device 310 and an image processing device 400. The imaging device 310 is connected to the image processing device 400 via a network 500. Description overlapping with the first example embodiment will be omitted as appropriate.

The image processing system 200 detects a person from a video captured by the imaging device 310 provided in a vehicle 300, and masks the person. The vehicle 300 is, for example, an automobile and may be a vehicle such as a truck or a bus. The imaging device 310 is provided in the vehicle 300. The imaging device 310 is a device that images a scene around the vehicle 300 and is, for example, a drive recorder. The imaging device 310 includes an imaging unit 311 and a communication unit 312. The imaging unit 311 is a camera. The imaging unit 311 images, for example, a scene in front of the vehicle 300, that is, a scene that a driver sitting in a driver's seat of the vehicle 300 can see. The orientation of the imaging unit 311 can be arbitrarily changed or may be in all directions. The communication unit 312 is a communication interface with the network 500. The communication unit 312 transmits the video captured by the imaging unit 311 to the image processing device 400 via the network 500.

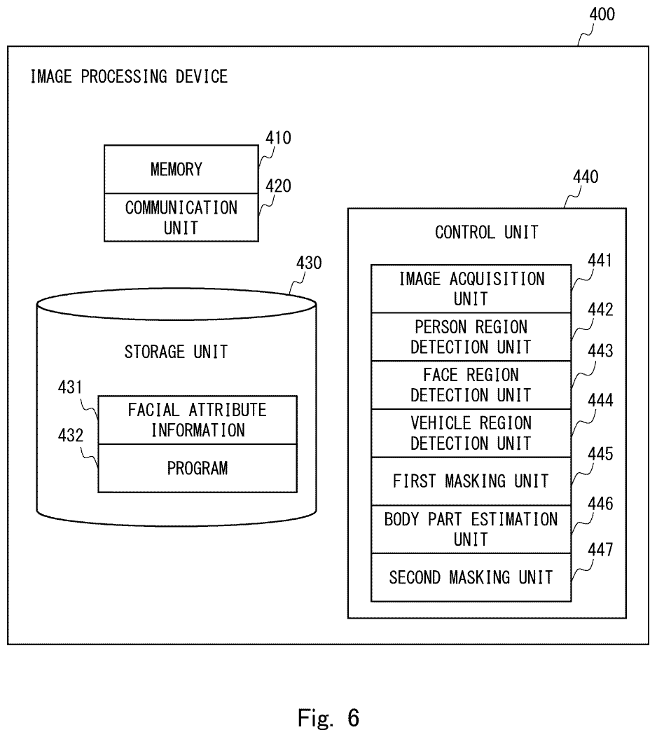

Next, a configuration of the image processing device 400 will be described in detail with reference to FIG. 6. FIG. 6 is a block diagram illustrating the configuration of the image processing device 400. The image processing device 400 includes a memory 410, a communication unit 420, a storage unit 430, and a control unit 440.

The memory 410 is a storage area for temporarily storing processing content of the control unit 440, and is, for example, a volatile storage device such as a random access memory (RAM). The communication unit 420 is an interface that communicates with the outside of the image processing device 400. The storage unit 430 is a storage device that stores person's facial attribute information 431, a program 432, and the like. The person's facial attribute information 431 may include, for example, various attributes (for example, gender, race, and age) determined from the face and body information for each attribute. The program 432 is a computer program in which image processing treatment according to the present example embodiment is implemented.

The control unit 440 includes an image acquisition unit 441, a person region detection unit 442, a face region detection unit 443, a vehicle region detection unit 444, a first masking unit 445, a body part estimation unit 446, and a second masking unit 447. The control unit 440 is a control device that controls an operation of the image processing device 400 and is, for example, a processor such as a CPU. The control unit 440 loads the program 434 from the storage unit 430 into the memory 410 and executes the program. Thus, the control unit 440 achieves functions of the image acquisition unit 441, the person region detection unit 442, the face region detection unit 443, the vehicle region detection unit 444, the first masking unit 445, the body part estimation unit 446, and the second masking unit 447.

The image acquisition unit 441 acquires image frames of the video transmitted from the imaging device 310. The video includes a plurality of consecutive frames. The video may include identification information and time information. The identification information is information for identifying the vehicle 300 in which the imaging device 310 that captures the video is provided. The time information is information regarding a time when the video is captured.

The person region detection unit 442 detects the person region for each frame included in the video acquired by the image acquisition unit 110. The face region detection unit 443 detects a face region estimated to be the face of the person from the image frame in which the person region is detected. The vehicle region detection unit 444 detects a vehicle region for each frame included in the video acquired by the image acquisition unit 110. A known vehicle region detection engine can be used.

In some example embodiments, the face region detection unit 443 can detect a face region of a person and identify attributes of the detected face (for example, age, gender, race, and the like).

In some example embodiments, the body part estimation unit 446 can estimate the body part based on the identified attributes of the face (for example, based on statistical data for each attribute). For example, for a child, the body part may correspond to a length equivalent to four to five times the head height from the detected face region. For example, for an adult man, the body part may correspond to a length equivalent to seven times the head height from the detected face region. For example, for an adult woman, the body part may correspond to a length equivalent to six times the head height from the detected face region. In another example embodiment, in the case of a man with a chubby face, the lateral width of the body part may be estimated to be wider than that of a normal man.

The lateral width of the body part may be estimated according to the aspect ratio of the face.

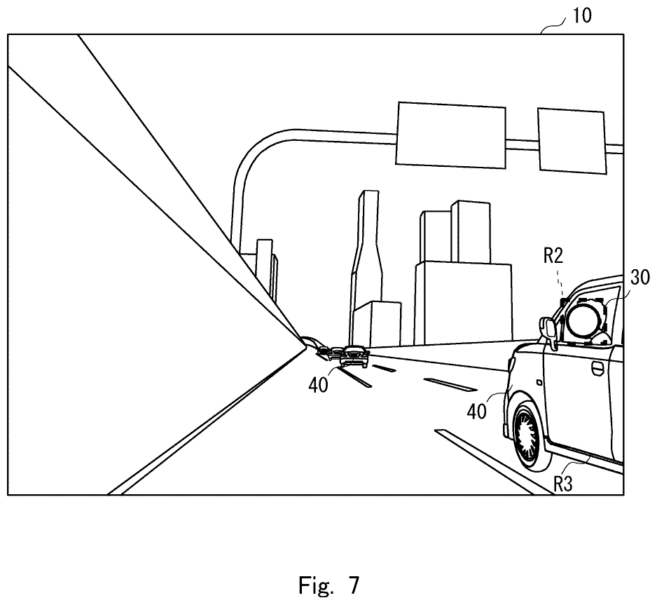

FIG. 7 is a diagram illustrating another example of an acquired video frame according to the second example embodiment. In FIG. 7, the person 30 in the vehicle 40 is detected. A face region R2 is detected by the face region detection unit 443, but a person region RI is not detected by the person region detection unit 442. When the body part estimation unit 446 estimates a body part from the face region R2 and the second masking unit 447 masks the estimated body part, a part of the vehicle is concealed. Such an image frame may not be used for various purposes. As illustrated in FIG. 7, in a case where the face region R2 is inside a vehicle region R3, the body part is not estimated, the second masking processing is not performed, and only the face region is masked. In FIG. 7, the vehicle 40 is illustrated as a standard automobile, but may be another vehicle such as a truck, a bus, or the like. For example, in the case of the bus, only face regions of a plurality of passengers or the face region of a driver can be masked.

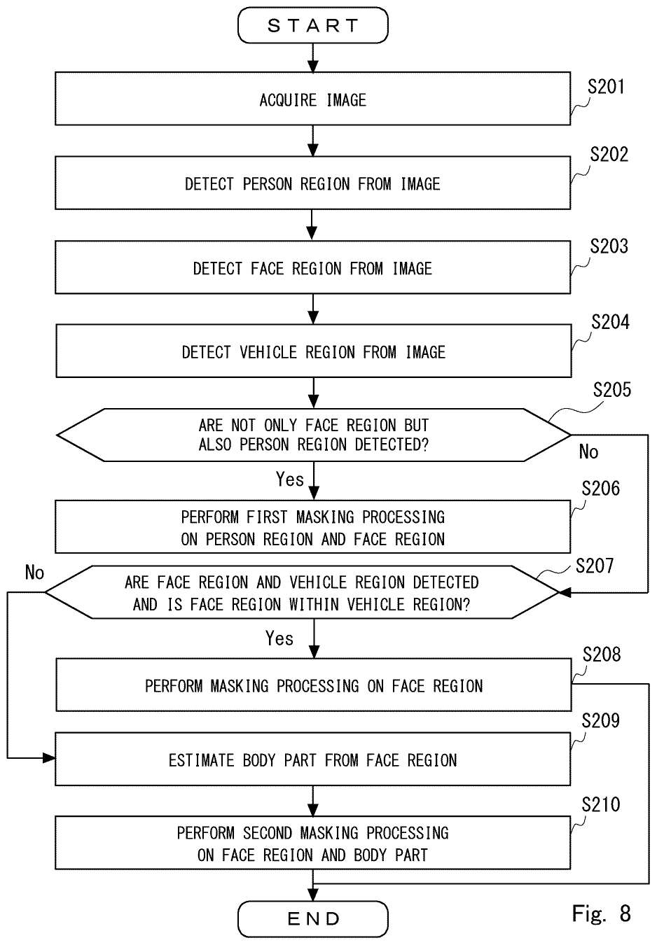

Next, an image processing method according to the second example embodiment will be described with reference to FIG. 8.

The image acquisition unit 441 acquires image frames of a video captured by the imaging device provided in the vehicle (step S201). The acquired image frames are stored in the storage device together with an acquired time, an acquired positional information (for example, latitude, longitude, and the like), and other information (for example, the weather at the position).

The person region detection unit 442 detects a person region estimated to be a person from the video acquired by the image acquisition unit 441 using the known person region detection engine (step S202). The face region detection unit 443 detects a face region estimated to be a face of the person from the image frame in which the person region is detected (step S203). The vehicle region detection unit 444 detects a vehicle region for each frame included in the video acquired by the image acquisition unit 110 (step S204). A known vehicle region detection engine can be used.

In a case where not only the face region but also the person region are detected (Yes in step S205), the first masking unit 445 performs masking processing on at least a part or all of the face region and person region detected in the frame (step S206).

On the other hand, as illustrated in FIG. 7, in a case where the face region is detected and the person detection is not detected (No in step S205), and in a case where the vehicle is detected and the face region is within the vehicle region (Yes in step S207), the face region detected by the face region detection unit 443 is masked. In other words, in a case where the face region is within the vehicle region, the body part is not estimated. Thus, it is possible to prevent a part of the vehicle from being concealed by masking the estimated body part of the person. Therefore, unnecessary masking can be prevented while protecting personal information, and the image frame can be used for various purposes.

On the other hand, in a case where the face region is detected and the person detection is not detected (No in step S205), and in a case where the vehicle is not detected or the face region is not within the vehicle region (No in step S207), the body part estimation unit 446 estimates the body part from the face region detected by the face region detection unit 443 (step S209). The body part estimation unit 446 can estimate the body part more accurately according to the identified attribute of the face. The second masking unit 447 masks at least a part of the face region and the estimated body part. Here, the masking processing is image processing performed on the region in such a way as not to be able to identify the person and the clothing and includes solid fill processing and filter processing. The first masking unit 445 and the second masking unit 447 may perform masking processing on a part of the person image region (for example, a part corresponding to the face). The masking processing includes filling, mosaicing, or blurring. In the masking processing, the person image can be replaced with an avatar corresponding to the attribute of the person while complying with personal information protection.

### Third Example Embodiment

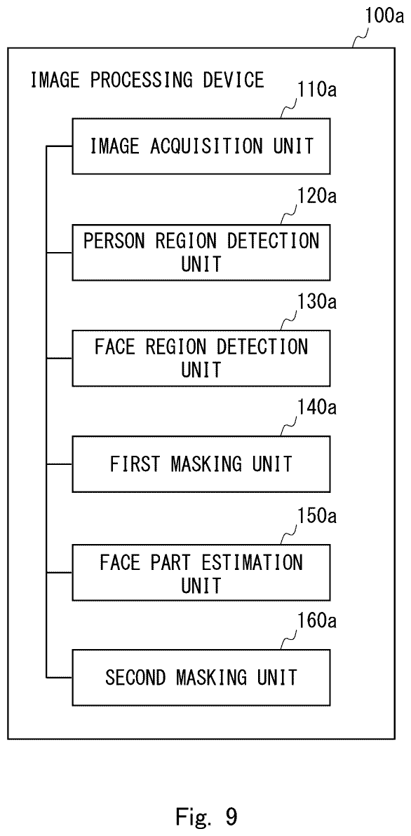

FIG. 9 is a block diagram illustrating a configuration of an image processing device according to a third example embodiment.

Contrary to the first example embodiment, in a case where the person region is detected and the face region is not detected, an image processing device 100a according to the present example embodiment estimates a face part of the person from the person region and masks the detected person region and the estimated face part. Specifically, the image processing device 100a includes an image acquisition unit 110a, a person region detection unit 120a, a face region detection unit 130a, a first masking unit 140a, a face part estimation unit 150a, and a second masking unit 160a.

The image acquisition unit 110a acquires an image. The person region detection unit 120a detects a person region estimated to be a person from the image. The face region detection unit 130a detects a face region estimated to be a face of the person from the image. In a case where the person region and the face region are detected from the image, the first masking unit 140a masks at least a part of the person region and the face region. In a case where the person region is detected and the face region is not detected from the image, the face part estimation unit 150a estimates the face part of the person from the person region. For example, it can be estimated that the face part of the person is present upward in a vertical direction from the detected person region. The second masking unit 160a masks at least a part or all of the detected person region and the estimated face part.

In the above-described example embodiments, the configuration of the hardware has been described, but the present disclosure is not limited thereto. According to the present disclosure, the processing illustrated in FIGS. 4 and 7 can also be achieved by causing a CPU to execute a computer program.

In the example described above, the program includes a group of instructions (or software codes) for causing a computer to execute one or more functions described in the example embodiments in a case where the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or another memory technology, a CD-ROM, a digital versatile disc (DVD), a Blu-ray (registered trademark) disk, or another optical disk storage, and a magnetic cassette, a magnetic tape, a magnetic disk storage, or another magnetic storage device. The program may be transmitted on a transitory computer-readable medium or a communication medium. As an example and not by way of limitation, transitory computer-readable or communication media include electrical, optical, acoustic, or other forms of propagated signals.

Note that the present disclosure is not limited to the above-described example embodiments, and can be appropriately changed without departing from the scope. The present disclosure may be implemented by appropriately combining the example embodiments. The functions of the image acquisition unit 110, the person region detection unit 120, the face region detection unit 130, the first masking unit 140, the body part estimation unit 150, and the second masking unit 160 of the image processing device 100 may be provided in the imaging device 310 of each vehicle 300. Similarly, the functions of the image acquisition unit 441, the person region detection unit 442, the face region detection unit 443, the vehicle region detection unit 444, the first masking unit 445, the body part estimation unit 446, and the second masking unit 447 of the image processing device 400 may be provided in the imaging device 310 of each vehicle 300. Thus, the imaging device 310 of each vehicle 300 can individually detect a person and execute masking processing.

While the present invention has been particularly shown and described with reference to example embodiments thereof, the present invention is not limited to these example embodiments. It will be understood by those of ordinary skill in the art that various changes in form and details may be made therein without departing from the spirit and scope of the present disclosure as defined by the claims.

Some or all of the above-described example embodiments may also be described as the following supplementary notes, but are not limited to the following supplementary notes.

### Supplementary Note 1

An image processing device including:
an image acquisition unit that acquires an image;
a person region detection unit that detects a person region estimated to be a person from the image;
a face region detection unit that detects a face region estimated to be a face of the person from the image;
a first masking unit that masks at least a part of the person region and the face region in a case where the person region and the face region are detected from the image;
a body part estimation unit that estimates a body part of the person from the face region in a case where the face region is detected and the person region is not detected from the image; and
a second masking unit that masks at least a part of the detected face region and the estimated body part.

### Supplementary Note 2

The image processing device according to Supplementary Note 1, in which the body part estimation unit identifies an attribute from the detected face region and estimates the body part according to the attribute.

### Supplementary Note 3

The image processing device according to Supplementary Note 1, further including a vehicle region detection unit that detects a vehicle region estimated to be a vehicle from the image,
in which in a case where the detected face region is within the vehicle region,
the body part estimation unit refrains from estimating the body part of the person from the face region, and
the second masking unit masks at least a part of the face region.

### Supplementary Note 4

The image processing device according to Supplementary Note 1, in which the masking includes filling, mosaicing, or blurring on at least a part of the person region and the face region.

### Supplementary Note 5

The image processing device according to Supplementary Note 4, in which the masking includes disposing an avatar corresponding to an attribute of the person on the person region and the face region.

### Supplementary Note 6

An image processing method including:
acquiring an image;
detecting a person region estimated to be a person from the image;
detecting a face region estimated to be a face of the person from the image;
masking at least a part of the person region and the face region in a case where the person region and the face region are detected from the image;
estimating a body part of the person from the face region in a case where the face region is detected and the person region is not detected from the image; and
masking at least a part of the detected face region and the estimated body part.

### Supplementary Note 7

A non-transitory computer-readable medium storing a program that causes a computer to:
acquire an image;
detect a person region estimated to be a person from the image;
detect a face region estimated to be a face of the person from the image;
mask at least a part of the person region and the face region in a case where the person region and the face region are detected from the image;
estimate a body part of the person from the face region in a case where the face region is detected and the person region is not detected from the image; and
mask at least a part of the detected face region and the estimated body part.

### Supplementary Note 8

An image processing device including:
an image acquisition unit that acquires an image;
a person region detection unit that detects a person region estimated to be a person from the image;
a face region detection unit that detects a face region estimated to be a face of the person from the image;
a first masking unit that masks at least a part of the person region and the face region in a case where the person region and the face region are detected from the image;
a face part estimation unit that estimates a face part from the person region in a case where the person region is detected and the face region is not detected from the image; and
a second masking unit that masks at least a part of the detected person region and the estimated face part.

### Supplementary Note 9

An image processing method including:
acquiring an image;
detecting a person region estimated to be a person from the image;
detecting a face region estimated to be a face of the person from the image;
masking at least a part of the person region and the face region in a case where the person region and the face region are detected from the image;
estimating a face part from the person region in a case where the person region is detected and the face region is not detected from the image; and
masking at least a part of the detected person region and the estimated face part.

### Supplementary Note 10

A non-transitory computer-readable medium storing a program that causes a computer to:
acquire an image;
detect a person region estimated to be a person from the image;
detect a face region estimated to be a face of the person from the image;
mask at least a part of the person region and the face region in a case where the person region and the face region are detected from the image;
estimate a face part from the person region in a case where the person region is detected and the face region is not detected from the image; and
mask at least a part of the detected person region and the estimated face part.

### REFERENCE SIGNS LIST

10 frame
30 person
40 vehicle
50 roadway
100 image processing device
100a image processing device
110 image acquisition unit
110a image acquisition unit
120 person region detection unit
120a person region detection unit
130 face region detection unit
130a face region detection unit
140 first masking unit
140a first masking unit
150 body part estimation unit
150a face part estimation unit
160a second masking unit
400 image processing device
410 memory
420 communication unit
430 storage unit
431 facial attribute information
432 program
440 control unit
441 image acquisition unit
442 person region detection unit
443 face region detection unit
444 vehicle region detection unit
445 first masking unit
446 body part estimation unit
447 second masking unit
200 image processing system
300 vehicle
310 imaging device
311 imaging unit
312 communication unit
500 network
R1 person region
R2 face region
R3 vehicle region
BD body part

What is claimed is:

1. An image processing device comprising:
at least one memory storing instructions, and
at least one processor configured to execute the instructions to:
acquire an image;
detect a person region estimated to be a person from the image;
detect a face region estimated to be a face of the person from the image;
mask at least a part of the person region and the face region in a case where the person region and the face region are detected from the image;
estimate a body part of the person from the face region in a case where the face region is detected and the person region is not detected from the image; and
mask at least a part of the detected face region and the estimated body part.

2. The image processing device according to claim 1, wherein the at least one processor is configured to execute the instructions to identify an attribute from the detected face region and estimates the body part according to the attribute.

3. The image processing device according to claim 1, wherein the at least one processor is configured to execute the instructions to detect a vehicle region estimated to be a vehicle from the image,
in a case where the detected face region is within the vehicle region,
refrain from estimating the body part of the person from the face region, and
mask at least a part of the face region.

4. The image processing device according to claim 1, wherein the masking includes filling, mosaicing, or blurring on at least a part of the person region and the face region.

5. The image processing device according to claim 4, wherein the masking includes disposing an avatar corresponding to an attribute of the person on the person region and the face region.

6. An image processing method comprising:
acquiring an image;
detecting a person region estimated to be a person from the image;
detecting a face region estimated to be a face of the person from the image;
masking at least a part of the person region and the face region in a case where the person region and the face region are detected from the image;
estimating a body part of the person from the face region in a case where the face region is detected and the person region is not detected from the image; and
masking at least a part of the detected face region and the estimated body part.

7. A non-transitory computer-readable medium storing a program that causes a computer to:
acquire an image;
detect a person region estimated to be a person from the image;
detect a face region estimated to be a face of the person from the image;
mask at least a part of the person region and the face region in a case where the person region and the face region are detected from the image;
estimate a body part of the person from the face region in a case where the face region is detected and the person region is not detected from the image; and
mask at least a part of the detected face region and the estimated body part.

8-10. (canceled)
